(19) United States
(12) Patent Application Publication
(10) Pub. No.: US 2008/0055597 A1
(43) Pub. Date: Mar. 6, 2008

(54) METHOD FOR CHARACTERIZING LINE WIDTH ROUGHNESS (LWR) OF PRINTED FEATURES

(76) Inventors: Jie-Wei Sun, Kao-Hsiung City (TW); Wen-Kai Hung, Penghu County (TW); Benjamin Szu-Min Lin, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/467,930

(22) Filed: Aug. 29, 2006

(51) Int. Cl. G01J 4/00; G01B 11/14

(52) U.S. Cl. 356/369; 356/625; 356/445

(57) ABSTRACT

A method for characterizing line width roughness of printed features is provided. A wafer having thereon a plurality of gratings formed within a test key region is prepared. The wafer is transferred to a spectroscopic ellipsometry tool having a light source, a detector and a computer. A polarized light beam emanated from the light source is directed onto the gratings. Spectrum data of reflected light is measured and recorded. The spectrum data is compared to a library linked to the computer in real time. The library contains a plurality of contact-hole model based spectra created by incorporating parameter values that describes the line width roughness. The spectrum data is matched with the contact-hole model based spectra, thereby determining the parameter values.

### BACKGROUND OF THE INVENTION

1. Field of the Invention

The present invention relates generally to the fabrication of semiconductor devices and, more particularly, the present invention relates to a non-destructive method for measuring and characterizing line width roughness (LWR) of a printed feature.

2. Description of the Prior Art

In the semiconductor industry, there is a continuing trend toward higher device densities. To achieve these high densities there has been and continues to be efforts toward scaling down the device dimensions on semiconductor wafers. Because critical dimensions (CDs) shrink by one-half every six years, lines tend to lose definition, which makes them rougher. This sidewall roughness that is usually called Line Edge Roughness (LER) or more correctly Line Width Roughness (LWR) is one of the most worrisome non-tool-related hurdles faced by next-generation lithography.

LER, which is a persistent problem for 193-nm lithography, refers to the variations on the sidewalls of patterned features or random fluctuations in the width of a resist feature. It is known that LER affects the electrical properties, especially threshold voltage variations of MOS transistors. Considerable efforts have been devoted to moderating LER, as well as more understanding its impact on devices.

The measurement of LER has recently become a major topic of concern in the litho-metrology community. As known in the art, LER is conventional measured by utilizing electron-based CD metrology tools such as CD-Scanning Electron Microscope (CD-SEM) imaging technology. However, the conventional CD-SEM imaging technology is destructive and may result in damage to the 193-nm photoresist pattern and undesirable electric charging on the dielectric materials.

Therefore, there is a need in this industry to provide a non-destructive LER measurement metrology technique that can be used for real-time, in-line control of an advanced semiconductor pattern transfer process, thereby preventing LER from affecting device performance.

### SUMMARY OF THE INVENTION

It is one object of the present invention to provide a non-destructive method for measuring and assessing line width roughness (LWR) of a printed feature by utilizing an optical CD metrology tool in order to solve the above-mentioned problems.

According to the claimed invention, a method for characterizing line width roughness of printed features is provided. A wafer having thereon a plurality of gratings formed within a test key region is prepared. The wafer is transferred to a spectroscopic ellipsometry tool. The spectroscopic ellipsometry tool has a light source, a detector and a computer. A polarized light beam emanated from said light source is directed onto the gratings. Spectrum data of reflected light is measured and recorded. The spectrum data is compared to a library linked to the computer in real time. The library contains a plurality of contact-hole model based spectra created by incorporating parameter values that describes the line width roughness. The spectrum data is matched with the contact-hole model based spectra, thereby determining the parameter values.

The parameter values comprise a diameter “a” on x-axis of a contact hole pattern that decides line critical dimension, a diameter “b” on y-axis of the contact hole pattern, rectangularity r, ellipticity (a/b), a first pitch on x-axis, a second pitch on y-axis, wherein a is diameter on x-axis of contact hole pattern and b is diameter on y-axis of contact hole pattern. The rectangularity r, ellipticity (a/b), first pitch on x-axis, and second pitch on y-axis decide the line edge roughness of the printed features.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a schematic diagram demonstrating the SCD measurement technique for characterizing LWR of a printed feature in accordance with one preferred embodiment of this invention;

FIG. 2 are schematic diagram showing the parameter values and equation used to construct the library according to this invention; and

FIGS. 3-5 are examples of the line/space patterns in the library representing different LWR conditions, which are simulated based on contact hole model according to this invention.

### DETAILED DESCRIPTION

Smaller device and dimensions and tighter process control windows have created a need for CD metrology tools having higher levels of precision and accuracy. As critical dimensions (CD) for semiconductor devices shrink to a few tens of nanometers, the line edge roughness (LER) and line width roughness (LWR) becomes a critical issue.

As previously described, LER of a patterned line is an accumulation of the roughness originating from the resist, materials and etch. At the 90-nm and below, controlling the cross-sectional profile of critical layer structures such as gate patterning is key to maximizing yield and transistor performance.

The present invention pertains to a non-destructive, optical method for measuring and characterizing line width roughness (LWR) of a printed feature such as a critical layer of resist lines, which provides chipmakers with an effective in-line process control. The non-destructive, optical method of this invention is implemented using a spectroscopic critical dimension (SCD) optical metrology technique based on spectroscopic ellipsometry (SE), which is typically used to measure film thickness and film properties. Traditional SCD metrology techniques give no indication of a measured feature's line width roughness. However, the non-destructive, optical method of this invention may use other optical technologies such as reflectometry. Known vendors include but not limited to Timbre OCD and NOVA OCD.

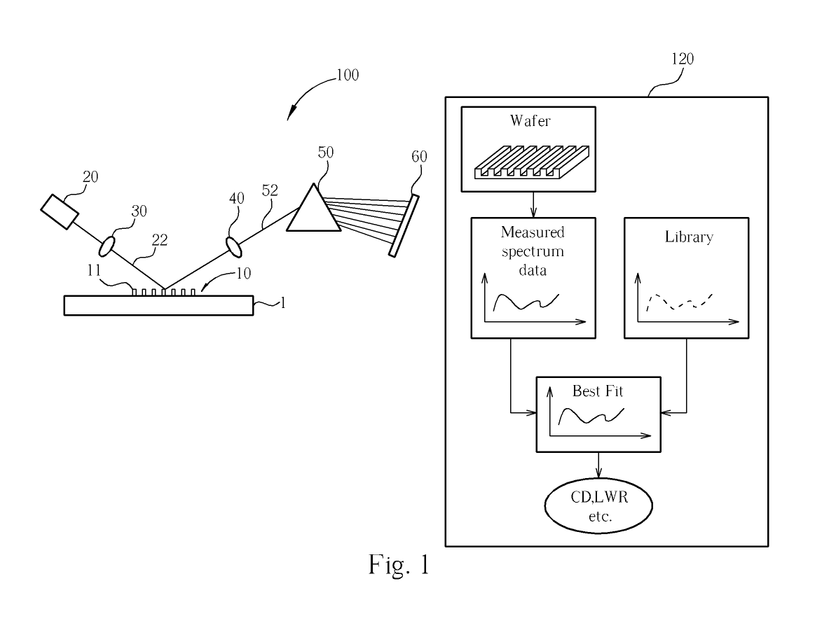

FIG. 1 is a schematic diagram demonstrating the SCD measurement for characterizing LWR of a printed feature in accordance with one preferred embodiment of this invention. As shown in FIG. 1, a wafer 1 having thereon a plurality of gratings 11 formed within a test key region 10 is provided. The test key region is preferably located on a scribe line. By way of example, the gratings are 50 μm×50 μm in size, but not limited thereto. According to this invention, the test key region may be placed on anywhere within a shot, with its size larger than light source.

The wafer 1 is transferred to the spectroscopic ellipsometry based SCD measurement tool 100 that is equipped with at least a broad-band light source 20, a rotating polarizer 30, an analyzer 40, a prism 50, an array detector 60 and a computer or data processing unit 120. For example, the SCD measurement tool 100 may be SpectroCD SCD measurement system available from KLA-Tencor Corp. or any equivalent systems.

According to the preferred embodiment, for example, the gratings 11 may be 3000-4000 angstrom photoresist lines over 100-200 angstrom bottom anti-reflection coating (BARC), but not limited thereto.

According to the preferred embodiment, for example, the gratings 11 are repeating line/space features of uniform period and have a line/space ratio of 80/100 nm (180 nm pitch). The line size and period of the grating are designed to represent the in-die feature that is being controlled.

Still referring to FIG. 1, a polarized light beam 22 emanated from the broad-band light source 20 is directed onto the gratings 11. Spectrum data of the reflected light 52 is measured by the array detector 60 and recorded using the computer 120. The measured spectrum data is real-time compared to a library.

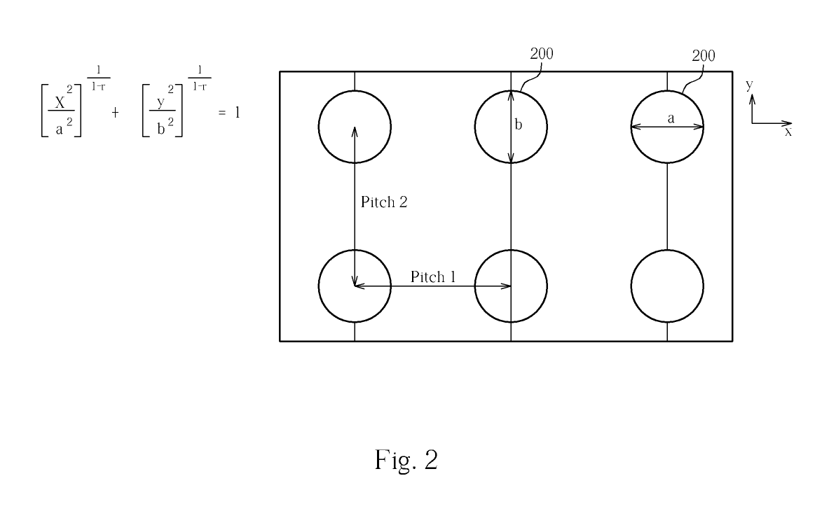

Please refer to FIG. 2. The library set forth in FIG. 1 contains contact-hole model based spectra created by incorporating parameter values that describe the line width roughness. The parameter values comprise a diameter “a” on x-axis of a contact hole pattern 200, a diameter “b” on y-axis, rectangularity r, ellipticity (a/b) of the contact hole pattern 200, a first pitch on the x-axis, and a second pitch on the y-axis, wherein the second pitch is smaller than diameter “b” on y-axis. The diameter “a” on x-axis of the contact hole pattern 200 decides the line critical dimension (CD).

The contact hole model is defined by the following equation:

(x²/a²)^{1/1-r}+(y²/b²)^{1/1-r}=1

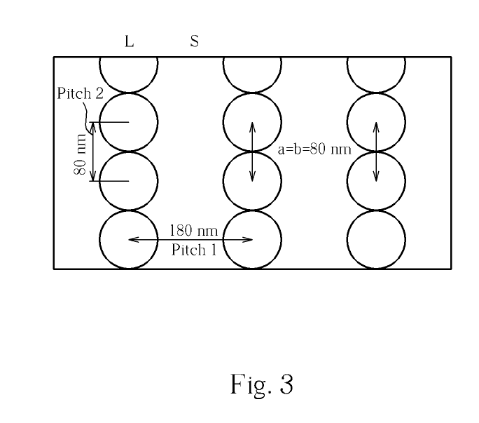

Varying the parameter values and calculating theoretical spectra construct the library. FIGS. 3-5 are some examples of the line/space patterns in the library representing different LWR conditions, which are simulated based on contact hole model. As shown in FIG. 3, the line pattern (L) is formed of a row of sequential contact hole patterns with the same size and dimension. Each contact hole pattern has a diameter “a” on x-axis, for example, 80 nm, a diameter “b” on y-axis, for example, 80 nm, a rectangularity r=0, ellipticity ratio E=a/b=1, a first pitch of 180 nm (L: 80 nm; space (S): 100 nm), and a second pitch of 80 nm.

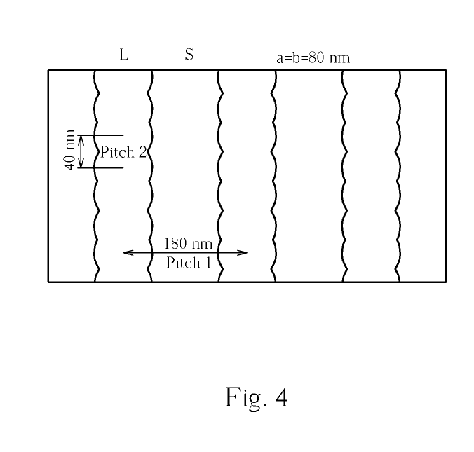

As shown in FIG. 4, each contact hole pattern has a diameter “a” on x-axis, for example, 80 nm, a diameter “b” on y-axis, for example, 80 nm, a rectangularity r=0, ellipticity ratio E=a/b=1, a first pitch of 180 nm (L: 80 nm; space (S): 100 nm), and a second pitch of 40 nm.

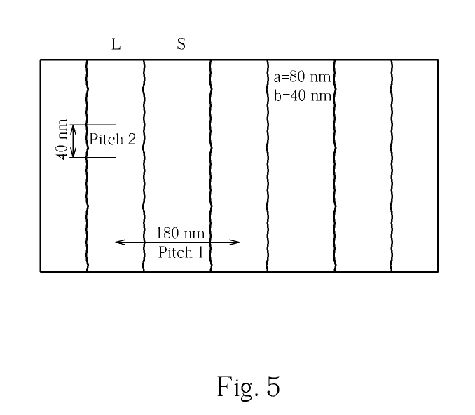

As shown in FIG. 5, each contact hole pattern has a diameter “a” on x-axis, for example, 80 nm, a diameter “b” on y-axis, for example, 40 nm, a rectangularity r=0, ellipticity ratio E=a/b=2, a first pitch of 180 nm (L: 80 nm; space (S): 100 nm), and a second pitch of 40 nm.

According to this invention, the present invention is particularly suited for a case that the L/S is less than 1/13.

Briefly referring back to FIG. 1, as the wafer is measured the data is compared to the library. The measured spectrum data is matched with the contact-hole model based spectra of the library, thereby determining the parameter values that describe the line width roughness.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for characterizing line width roughness of printed features, comprising:
preparing a wafer having thereon a plurality of gratings formed within a test key region;
transferring said wafer to an optical tool comprising a light source, a detector and a computer;
directing a polarized light beam emanated from said light source onto said gratings;
measuring and recording a spectrum data of reflected light;
comparing said spectrum data to a library linked to said computer, wherein said library contains a plurality of contact-hole model based spectra created by incorporating parameter values that describes said line width roughness; and
matching said spectrum data with said contact-hole model based spectra, thereby determining said parameter values.

2. The method according to claim 1 wherein said optical tool comprises a spectroscopic ellipsometry tool and a reflectometry tool.

3. The method according to claim 1 wherein said parameter values comprise a diameter on x-axis of contact hole pattern that decides line critical dimension.

4. The method according to claim 1 wherein said parameter values comprise a diameter on y-axis of a contact hole pattern.

5. The method according to claim 1 wherein said parameter values comprise rectangularity r.

6. The method according to claim 1 wherein said parameter values comprise ellipticity (a/b), a first pitch on x-axis, a second pitch on y-axis, which decide line edge roughness, wherein a is diameter on x-axis of contact hole pattern and b is diameter on y-axis of contact hole pattern.

7. The method according to claim 1 wherein said test key region is located on anywhere within a shot, with its size larger than light source.

8. The method according to claim 1 wherein said test key region is located on a scribe line.

9. The method according to claim 1 wherein said gratings are 50 μm×50 μm in size.

10. The method according to claim 1 wherein said gratings are repeating line/space features of uniform period.

11. The method according to claim 1 wherein said gratings have a line/space ratio less than 1/13.

12. The method according to claim 1 wherein said gratings have a line/space ratio of 80/100 nm (180 nm pitch).

13. The method according to claim 1 wherein said gratings are resist lines.

14. The method according to claim 1 wherein said light source comprises a broadband light source.

15. A method for characterizing line width roughness of printed features, comprising:
preparing a wafer having thereon a plurality of gratings formed within a test key region;
transferring said wafer to an optical tool comprising a light source, a detector and a computer;
directing a polarized light beam emanated from said light source onto said gratings;
measuring and recording a spectrum data of reflected light;
comparing said spectrum data to a library linked to said computer in real time, wherein said library contains a plurality of modeled spectra created by incorporating parameter values that describes said line width roughness, wherein said parameter values comprise a diameter “a” on x-axis of a contact hole pattern that decides line critical dimension, a diameter “b” on y-axis of said contact hole pattern, rectangularity r, ellipticity (a/b), a first pitch on said x-axis, and a second pitch on said y-axis; and
matching said spectrum data with said modeled spectra, thereby determining said parameter values.

16. The method according to claim 15 wherein said optical tool comprises a spectroscopic ellipsometry tool and a reflectometry tool.

17. The method according to claim 15 wherein said test key region is located on a scribe line.

18. The method according to claim 15 wherein said gratings are 50 μm×50 μm in size.

19. The method according to claim 15 wherein said gratings are repeating line/space features of uniform period.

20. The method according to claim 15 wherein said gratings are resist lines.

21. The method according to claim 15 wherein said light source comprises a broadband light source.
